(19) United States
(12) Patent Application Publication
(10) Pub. No.: US 2014/0157206 A1
(43) Pub. Date: Jun. 5, 2014

(54) MOBILE DEVICE PROVIDING 3D INTERFACE AND GESTURE CONTROLLING METHOD THEREOF

(71) Applicant: SAMSUNG ELECTRONICS CO., LTD., Suwon-Si (KR)

(72) Inventors: Ilia OVSIANNIKOV, Pasadena, CA (US); Dong-Ki MIN, Seoul (KR); Yoon-dong PARK, Osan-si (KR)

(73) Assignee: SAMSUNG ELECTRONICS CO., LTD., Suwon-Si (KR)

(21) Appl. No.: 13/828,576

(22) Filed: Mar. 14, 2013

Related U.S. Application Data
(60) Provisional application No. 61/731,667, filed on Nov. 30, 2012.

(51) Int. Cl. G06F 3/0481; G06F 3/0485

(52) U.S. Cl. CPC G06F 3/04815; G06F 3/0485
USPC 715/849

(57) ABSTRACT

Disclosed is a gesture control method for a mobile device that provides a three-dimensional interface. The gesture control method includes displaying a virtual three-dimensional space using the three-dimensional interface; detecting at least one gesture of at least one user using at least one front-facing sensor; and moving an object existing in the virtual three-dimensional space according to the detected gesture such that the at least one user interacts with the virtual three-dimensional space.

### CROSS-REFERENCE TO RELATED APPLICATIONS

This U.S. non-provisional patent application claims priority under 35 U.S.C. §119 of U.S. Provisional Application No. 61/731,667, filed on Nov. 30, 2012, the entire contents of which are hereby incorporated by reference.

### BACKGROUND

Example embodiments of inventive concepts described herein relate to a mobile device providing a three-dimensional interface and/or a gesture controlling method thereof.

A terminal may become a complex terminal that has a variety of multimedia functions. One of the multimedia functions may be a camera function. A user may capture an image using a camera to display or transmit the captured image. A general image processing device including the camera may process a two-dimensional image captured by the one camera. Images seen through left and right eyes of a human may be different from each other. As is well known, it is possible to express an image in three dimensions by synthesizing images respectively seen through left and right eyes. In other words, an image processing device may express a three-dimensional image by synthesizing images respectively captured by a plurality of cameras.

### SUMMARY

Some example embodiments of inventive concepts provide a gesture control method of a mobile device that provides a three-dimensional interface, the method including displaying a virtual three-dimensional space using the three-dimensional interface; detecting at least one gesture of at least one user using at least one front-facing sensor; and moving an object existing in the virtual three-dimensional space according to the detected gesture such that the at least one user interacts with the virtual three-dimensional space.

In some example embodiments, the gesture control method further comprises generating an avatar corresponding to a hand of the at least one user based on location information of the at least one user.

In some example embodiments, the gesture control method further comprises displaying a three-dimensional scene corresponding to a still space in the virtual three-dimensional space such that the at least one user is immersed in the three-dimensional space, the still space associated with a peripheral circumstance of the at least one user; displaying the three-dimensional scene as if a cube is floated in the still space; and changing an appearance of the cube displayed according to a motion of the mobile device or the at least one user when the mobile device or the at least one user moves, such that a location of the cube is not moved within the three-dimensional space.

In some example embodiments, the changing an appearance of the cube comprises displaying a left side of the cube more compared with the appearance of the cube before the at least one user moves if a head of the at least one user moves leftward.

In some example embodiments, the gesture control method further comprises acquiring and tracing coordinates of eyes of the at least one user within a physical three-dimensional space using the at least one front-facing sensor.

In some example embodiments, the gesture control method further comprises varying the virtual three-dimensional space according to the coordinates of the eyes such that the at least one user is immersed in the virtual three-dimensional space.

In some example embodiments, the gesture control method further comprises displaying the virtual three-dimensional space to superimpose the virtual three-dimensional space on a physical scene that the at least one users watches.

In some example embodiments, the gesture control method further comprises generating an avatar of the at least one user in the virtual three-dimensional space; and communicating with another user other than the at least one user using the generated avatar.

In some example embodiments, the gesture control method further comprises selecting an object of the virtual three-dimensional space based on pinching by the at least one user.

In some example embodiments, the gesture control method further comprises entering a resizing mode for resizing the object selected based on squeezing by the at least one user.

In some example embodiments, the gesture control method further comprises terminating the resizing mode when the selected object is not resized during a desired time.

In some example embodiments, the gesture control method further comprises moving the object based on pushing the object with at least one of a hand of the at least one user and a hand of an avatar corresponding to the hand of the at least one user.

In some example embodiments, the gesture control method further comprises panning the object based on rotating the object with at least one of a hand of the at least one user and a hand of an avatar corresponding to the hand of the at least one user.

Some example embodiments of inventive concepts also provide a mobile device that provides a three-dimensional interface, the mobile device including a communication unit configured to perform wireless communication; a memory unit configured to store user data and data; a display unit configured to display a virtual three-dimensional space using the three-dimensional interface; a sensing unit configured to sense a still picture and a moving picture of a physical space and including at least one front-facing sensor configured to sense at least one gesture of a user; and at least one processor configured to control the communication unit, the memory unit, the display unit, and the sensing unit, wherein the at least one processor moves an object existing in the virtual three-dimensional space according to the detected gesture; and when the mobile device or the user moves, the at least one processor controls the three-dimensional interface such that a sight of the user toward the object is varied.

In some example embodiments, the front-facing sensor is a time-of-flight camera.

Some example embodiments of inventive concepts provide a gesture control method of a mobile device that provides a three-dimensional interface, the method including displaying a first portion of a virtual three-dimensional space so that the first portion is superimposed on a physical space, using the three dimensional interface; displaying a second portion of the virtual three-dimensional space using the three-dimensional interface; detecting at least one gesture of at least one user using at least one of one or more front-facing sensors and one or more back-facing sensors; and moving an object existing in the virtual three-dimensional space according to the detected gesture such that the at least one user interacts with the virtual three-dimensional space.

In some example embodiments, the second portion of the virtual three-dimensional space includes a floating cube.

In some example embodiments, the method includes changing an appearance of the cube according to a motion of the mobile device or the at least one user when the mobile device or the at least one user moves, such that a location of the cube is not moved within the three-dimensional space.

In some example embodiments, the method includes generating a hand of an avatar corresponding to a hand of the at least one user based on location information of the at least one user.

In some example embodiments, the method includes interacting with an object in the virtual three-dimensional space based on movement of the hand of the avatar.

### BRIEF DESCRIPTION OF THE FIGURES

The above and other objects and features will become apparent from the following description with reference to the following figures, wherein like reference numerals refer to like parts throughout the various figures unless otherwise specified, and wherein

FIG. 1 is a block diagram schematically illustrating a mobile device according to some example embodiments of inventive concepts.

FIG. 2 is a diagram illustrating an example in which a hand of a user is placed behind a screen of a mobile device within a virtual three-dimensional space according to some example embodiments of inventive concepts.

FIG. 3 is a diagram illustrating a see-through window to an improved immersion effect when a user watches a virtual three-dimensional scene by a mobile device according to some example embodiments of inventive concepts.

FIGS. 4 to 10 are diagrams illustrating interacting operations according to a gesture of a hand.

FIG. 11 is a flow chart illustrating a gesture control method of a mobile device according to some example embodiments of inventive concepts.

### DETAILED DESCRIPTION

Example embodiments will be described in detail with reference to the accompanying drawings. Example embodiments of inventive concepts, however, may be embodied in various different forms, and should not be construed as being limited only to the illustrated example embodiments.

Unless otherwise defined, all terms (including technical and scientific terms) used herein have the same meaning as commonly understood by one of ordinary skill in the art to which example embodiments of inventive concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

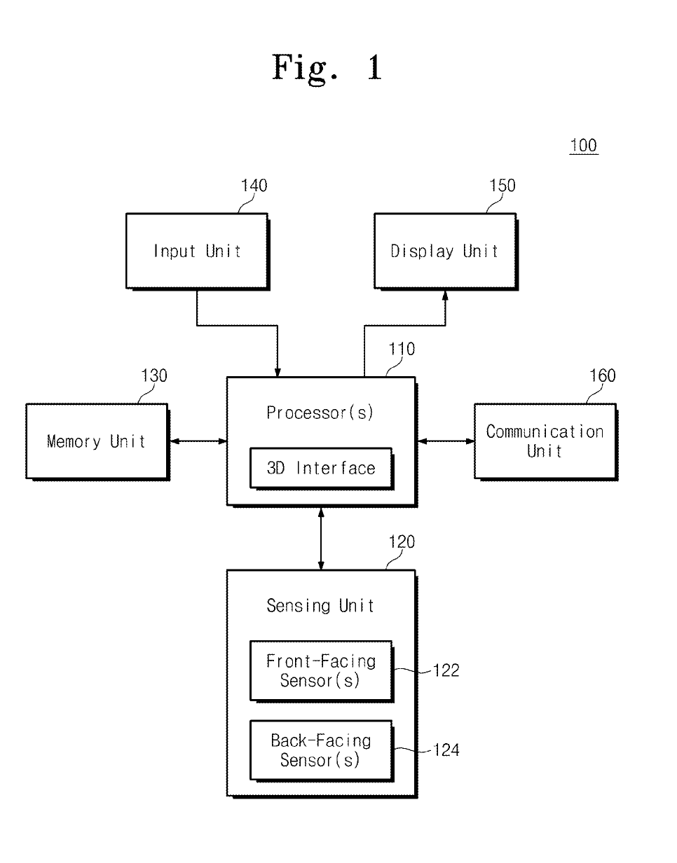

FIG. 1 is a block diagram schematically illustrating a mobile device according to some example embodiments of inventive concepts. Referring to FIG. 1, a mobile device 100 may include at least one processor 110, a sensing unit 120, a memory unit 130, an input unit 140, a display unit 150, and a communication unit 160. The mobile device 100 may be a netbook, a smart phone, a tablet, a handheld game console, a digital still camera, a camcorder, or the like.

The processor 110 may control an overall operation of the mobile device 100. For example, the processor 110 may process and control telephone conversation and data communication. In particular, the processor 110 may make a three-dimensional interface. The three-dimensional interface may be configured to generate a virtual three-dimensional space and to allow interaction between a user and the virtual three-dimensional space. Herein, the virtual three-dimensional space displayed may appear to a user as if it is formed at a rear or front surface of the mobile device 100.

The sensing unit may be configured to sense a still picture, an image or a gesture of a user. The sensing unit 120 may include at least one front-facing sensor 122 and at least one back-facing sensor 124 that sense at least one gesture of at least one user.

The front-facing sensor 122 and the back-facing sensor 124 may be a 2D camera or a three-dimensional camera (e.g., a stereo camera or a camera using a time of flight (TOF) principle).

The front-facing sensor 122 may transfer data associated with a gesture to the processor 110, and the processor 110 may classify an identifiable gesture region by pre-processing the data associated with the gesture using Gaussian filtering, smoothing, gamma correction, image equalization, age recover or image correction, etc. For example, specific regions such as a hand region, a face region, a body region, etc. may be classified from the pre-processed data using color information, distance information, etc., and masking may be performed with respect to the classified specific regions.

An operation of recognizing a user gesture may be performed by the processor 110. However, example embodiments of inventive concepts are not limited thereto. The gesture recognizing operation can be performed by the front-facing sensor 122 and/or the back-facing sensor 124 of the sensing unit 120.

In some example embodiments, the front-facing sensor 122 may acquire and trace a location of a user, coordinates of the user's eyes etc.

The memory unit 130 may include a ROM, a RAM, and a flash memory. The ROM may store process and control program codes of the processor 110 and the sensing unit 120 and a variety of reference data. The RAM may be used as a working memory of the processor 110, and may store temporary data generated during execution of programs. The flash memory may be used to store personal information of a user (e.g., a phone book, an incoming message, an outgoing message, etc.).

The input unit 140 may be configured to receive data from an external device. The input unit 140 may receive data using an operation in which a button is pushed or touched by a user. The input unit 140 may include a touch input device disposed on the display unit 150.

The display unit 150 may display information according to a control of the processor 110. The display unit 150 may be at least one of a variety of display panels such as a liquid crystal display panel, an electrophoretic display panel, an electrowetting display panel, an organic light-emitting diode panel, a plasma display panel, etc. The display unit 150 may display a virtual three-dimensional space using a three-dimensional interface.

The communication unit 160 may receive a wireless signal through an antenna. For example, during transmission, the communication unit 160 may make channel coding and spreading on data to be transmitted, make RF processing on the channel coded and spread result, and transmit an RF signal. During receiving, the communication unit 160 may recover data by converting an input RF signal into a baseband signal and de-spreading and channel decoding the baseband signal.

An electronic device providing a three-dimensional interface may interact as users touch a device screen, as gestures are made in front of a screen, or as gestures are made within a specified physical space such that gestures of a user and/or avatar expressions of a body are displayed on a screen. If a three-dimensional interface of a general electronic device is applied to a mobile device, however, a gesture must touch a screen or be in front of a screen. For this reason, generating a gesture by a user may hinder a view of a user watching a virtual three-dimensional space. Also, in a general electronic device, a hand of a user may only be placed outside a virtual three-dimensional space of an application. Due to an ergonomic problem, objects of a virtual three-dimensional space may not be allowed to hover in front of a screen, as this arrangement may increase fatigue on eyes of a user.

On the other hand, the mobile device 100 providing a three-dimensional interface may be configured to detect a gesture of a user and to shift an object of a virtual three-dimensional space according to the detected gesture. For example, a user may interact with a virtual three-dimensional space displayed by the mobile device 100 without blocking a view of a user. Also, a user may naturally reach a virtual three-dimensional space to operate objects of the virtual three-dimensional space. For example, the mobile device 100 according to some example embodiments of inventive concepts may run interactive applications having three-dimensional visualization. For example, the interactive application may enable a user to distinguish three-dimensional objects and to array distinguished objects again.

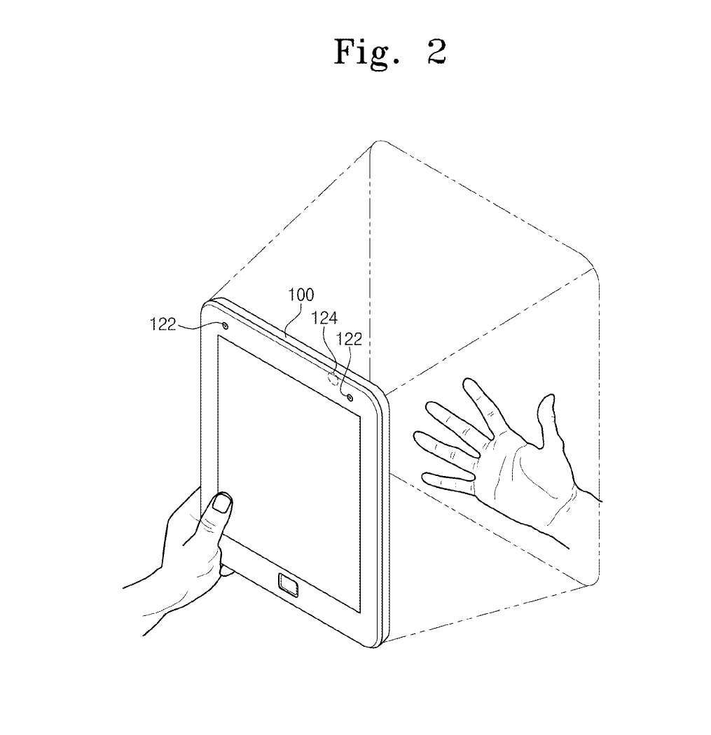

FIG. 2 is a diagram illustrating an example in which a hand of a user is placed behind a screen of a mobile device within a virtual three-dimensional space according to some example embodiments of inventive concepts. Referring to FIG. 2, a user may hold a mobile device 100 in a hand (e.g., a left hand) or at a relatively close distance (e.g., half the length of an arm).

As the mobile device 100 may have a relatively small size and therefore the location of the mobile device 100 may be relatively close to a user, the user may be able to reach a back of the mobile device 100. For example, the mobile device 100 may include a back-facing sensor 124 that senses a location of a right hand of the user if the mobile device 100 is held in the left hand of the user. The back-facing sensor 124 may be implemented by at least one back-facing time of flight camera. The camera may capture a location of the hand of the user at a back of the mobile device 100.

A three-dimensional interface of the mobile device 100 may receive data associated with location information of the user from at least one front-facing sensor 122 to generate avatar presentation of the user's hand based on the input data. For example, an avatar of the user may be displayed with the avatar's hand at the location of the user's hand. Alternatively, the avatar's hand may be displayed at a different location and the input data may be used to show relative movements so that movements of the avatar's hand mirrors movements of the user's hand.

To immerse a user in a virtual three-dimensional space, the three-dimensional interface of the mobile device 100 may compute a three-dimensional scene expressing a physical still space associated with a peripheral circumstance of a user in order to display a virtual three-dimensional scene. The ability of a user to reach a virtual three-dimensional space may increase the effect that the user is immersed in a virtual three-dimensional scene. As a result, a virtual three-dimensional scene may be smoothly inserted in a physical three-dimensional space.

For ease of description, it is assumed that a virtual three-dimensional space is placed in front of a user and a location of the virtual three-dimensional space is fixed by a physical three-dimensional space in which the user actually exists. For example, a cube may appear as if a virtual three-dimensional scene is floated in a physical three-dimensional space. When the head of the user moves or a screen of the mobile device 100 moves, a virtual three-dimensional scene may be displayed after such variations are compensated such that a location of a cube corresponding to a physical three-dimensional location is not varied. For example, the three-dimensional interface may calculate the movement of the user and mobile device 100 to display the cube so that the calculated movement is reflected in the appearance of the cube.

Although the head of a user may slightly move left, right, up, down, in and out, the user may become close to a screen, or the screen may slightly move within a physical three-dimensional space, a cube may appear to be floating in the same location in a virtual three-dimensional space. Although a three-dimensional object actually moves, the cube may appear as if it is floating in the same physical location. In particular, when the head of a user moves leftward, the user may see more of the left side of the cube

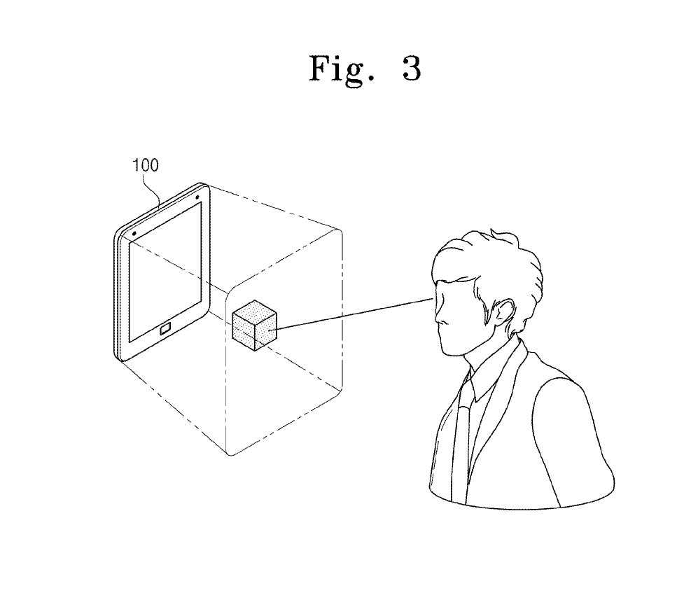

FIG. 3 is a diagram illustrating a see-through window to an improved immersion effect when a user watches a virtual three-dimensional scene by a mobile device according to some example embodiments of inventive concepts. Referring to FIG. 3, a mobile device 100 may compute a three-dimensional object display. A three-dimensional interface of the mobile device 100 may have an eye coordinate of the user, and may use an eyeball tracing technique to obtain the eye coordinate.

For example, at least one three-dimensional range TOF camera may be located in front of the mobile device for eye track activation of the user. When the TOF camera is used, it is easy to sense an eye of the user. The reason may be that a pupil of the eye reflects an infrared ray of the TOF camera. The mobile device 100 may further include sensors to track direction and location of the eye in a space.

The three-dimensional interface of the mobile device 100 may display a virtual still scene super-imposed on an actual image. At least one front-facing camera may catch locations of objects in a physical three-dimensional scene in front of the mobile device 100 to compute a three-dimensional view of the location. The virtual three-dimensional space may be super-imposed on and/or integrated with a physical still scene in view of the user. For example, additional objects or subjects may be displayed in a virtual three-dimensional scene.

The three-dimensional interface of the mobile device 100 may enable a user to reach a front or back of the mobile device 100 such that the user interacts with a virtual three-dimensional scene. For example, the mobile device 100 may capture an image using a stereo camera, and may display a virtual object moving using the captured three-dimensional scene. If the mobile device 100 moves, a view in which a virtual object corresponding to a movement is visible may be changed.

In some example embodiments, the three-dimensional interface of the mobile device 100 may display gestures of a plurality of users.

In some example embodiments, the three-dimensional interface may obtain and combine surrounding three-dimensional images of the user through a front-facing sensor 122 (e.g., three-dimensional range cameras or stereo cameras). The combined image may be used to produce a three-dimensional avatar image of the head and/or body of the user.

Optionally, the combined image may be used to produce an avatar image of a peripheral physical space of the user. The combined image may be stored, displayed, shared, and animated for the purpose of a communication, interaction, and entertainment. For example, a plurality of users may communicate with one another in real time using a virtual three-dimensional space. A user may watch another user in the virtual three-dimensional space displayed by the mobile device 100.

The three-dimensional interface of the mobile device 100 may be configured such that the front-facing sensor 122 acquires and tracks locations of the head and eye of the user. In particular, the three-dimensional interface may analyze the direction and location of a place at which a user looks or reacts. For example, if the three-dimensional interface includes animated subjects, the subjects may recognize that the user looks at the subjects, recedes, or reacts. In some example embodiments, reactions to an object may exist when the user watches subjects.

In addition to line of sight and/or location, the three-dimensional interface may be implemented to use information associated with a direction of the head of the user, a direction to which the user makes conversation, how close the head of the user is to a screen, motion and gestures of the head, facial motion, gestures and expressions, user identification, dresses, appearance of the user having makeup and hair, posture and hand gesture of the user, etc.

For example, in the three-dimensional interface, facial expressions of the user, gestures including eyes, facial expressions of the user approaching during interaction, or hands may react to gestures. The three-dimensional interface may recognize the user using face recognition techniques to analyze the user's appearance and reaction of the user to a corresponding user. The user may interact with the three-dimensional interface in a natural manner as though the user interacts with a person. The three-dimensional interface may analyze appearance, gestures, and expressions of the user like general persons.

The three-dimensional interface of the mobile device 100 according to some example embodiments of inventive concepts may be provided with information on locations of eyes of the user from a front-facing sensor that traces a head location of the user. The three-dimensional interface may use such information to optimize an immersion-type sound effect. For example, locations of eyes of the user may be used such that a sound generated from a virtual subject placed in a virtual three-dimensional space is heard from the specific virtual position of the virtual subject. Also, if the user wears a headphone, a head position may be used in the same manner to produce a sound generated in the specific virtual position like in reality.

The three-dimensional interface of the mobile device 100 according to some example embodiments of inventive concepts may be provided with information associated with an eye location and line and location of the sight for a specific type of a three-dimensional display to use and/or optimize a three-dimensional image from the front-facing sensor 122 that traces the eye location of the user. For example, a type of display may be based on information of an eye location such that an image displayed for a left eye is displayed in the left eye, not a right eye, and an image displayed for the right eye is displayed in the right eye, not the left eye.

Also, the front-facing sensor 122 may detect the presence of the user to track a location, motion expressions, lines of sight and locations of a plurality of users. For example, some three-dimensional displays based on eyeball tracking may transfer a three-dimensional image to a plurality of users. Thus, information on second or other users may be transferred to a three-dimensional display to activate operations of a plurality of users. Also, information on second or other users may be transferred to a three-dimensional interface to respond to presence, identification, actions, and expressions of the second user.

Information on the second and other users transferred to the three-dimensional interface responsible for maintaining a virtual three-dimensional space may be used to compute suitable views to activate an immersion effect for users. Information on body locations of the second and other users may be used to optimize a three-dimensional sound in the same manner as described for a main user. Additional users may interact with the mobile device 100 and a three-dimensional application by reaching a virtual space and/or making gestures in front of a screen. Effectively, all functions applied to a main user may be applied to the additional users.

A technique according to some example embodiments of inventive concepts may combine a three-dimensional visualization and interaction technique to achieve perfect fusion between a virtual reality and a physical reality. As a result, the user may reach the virtual reality from the physical reality. For example, the virtual reality may be observed and super-imposed on the physical reality.

Below, a method of controlling a gesture of a user will be more fully described. Two approach manners for interacting with a three-dimensional scene using three-dimensional gestures will be described. Two approach manners may be based on the ability of the user such that the hand of the user is disposed within a three-dimensional space.

First, a first gesture control method controlling single objects having flexibility and precision may be as follows. The user may move hands in three dimensions. Displayed objects approximating to an end of an index finger of the user may be highlighted to direct candidate objects to be selected.

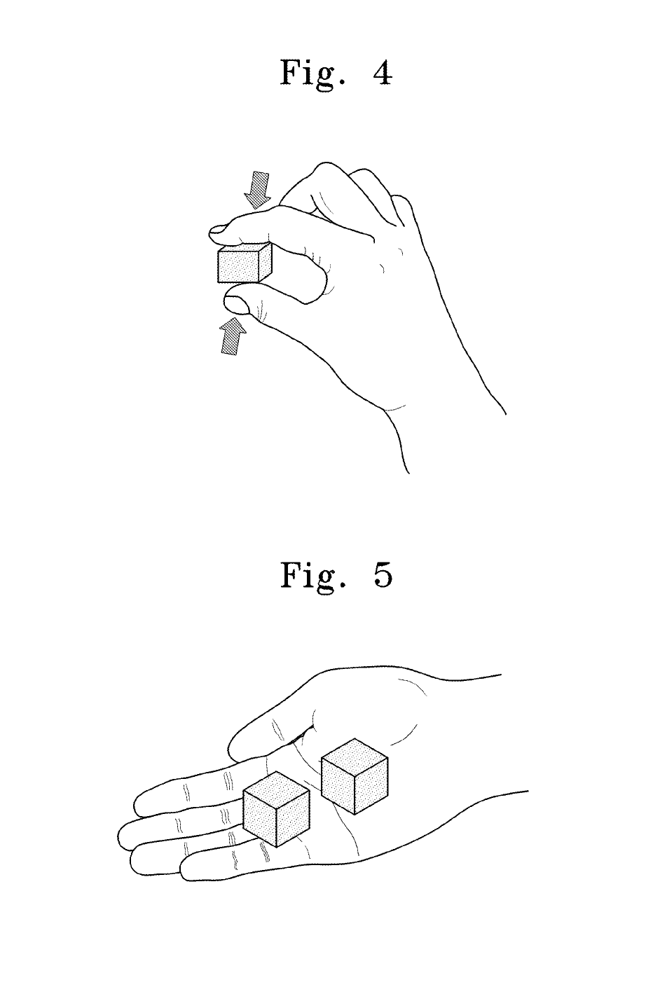

As illustrated in FIG. 4, a virtual object may be selected by “pinching.” The user may position his or her thumb and index finger fingertips to match the size of the object to be selected and optionally may hold for a moment to confirm the selection. Selection may be released by opening fingers wider. The object may be made smaller by “squeezing” it. Holding the size constant for a desired time may terminate the resizing mode. The object may be enlarged by first squeezing it to initiate the resize mode and then opening the thumb and index fingers wider than the original distance. Again, the resizing mode may be terminated by not changing size for a desired time.

Once selected, objects may be moved within a 3D space—left, right, up, down, in and out. Once selected, objects may be rotated axially, pitch-wise and yaw-wise. If object resizing is not needed, just pinching an object to move it and rotate it may be appropriate to provide a sufficient and natural way for the user to interact with objects within the scene, as if the objects were floating in a physical volume.

A second gesture control method controlling multiple objects at the same time may be as follows.

As illustrated in FIG. 5, one or more objects may be selected by cupping the hand and moving “under” (just behind) the object(s) and holding it for a desired time, as if holding it in the cup of one's hand. Objects may be deselected using the same gesture or a clear-all-selections gesture, for example by waving hand quickly across the volume. Alternatively, an object may be selected by moving a pointed finger to the object and holding it.

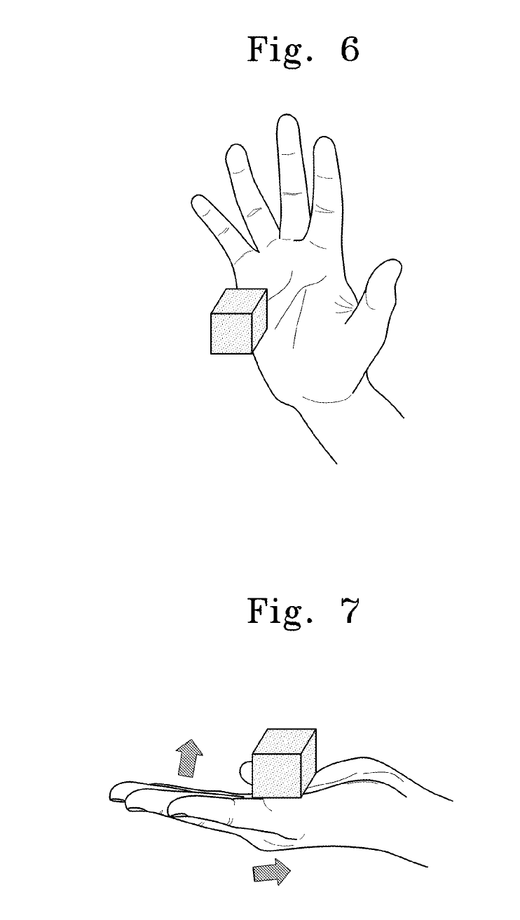

As illustrated in FIG. 6, object(s) may be moved to one side by “pushing” it with the hand. For a natural interaction, it may appear as if the hand actually pushes the objects.

As illustrated in FIG. 7, object(s) may be moved to another side by cupping the hand more and “pulling it.”

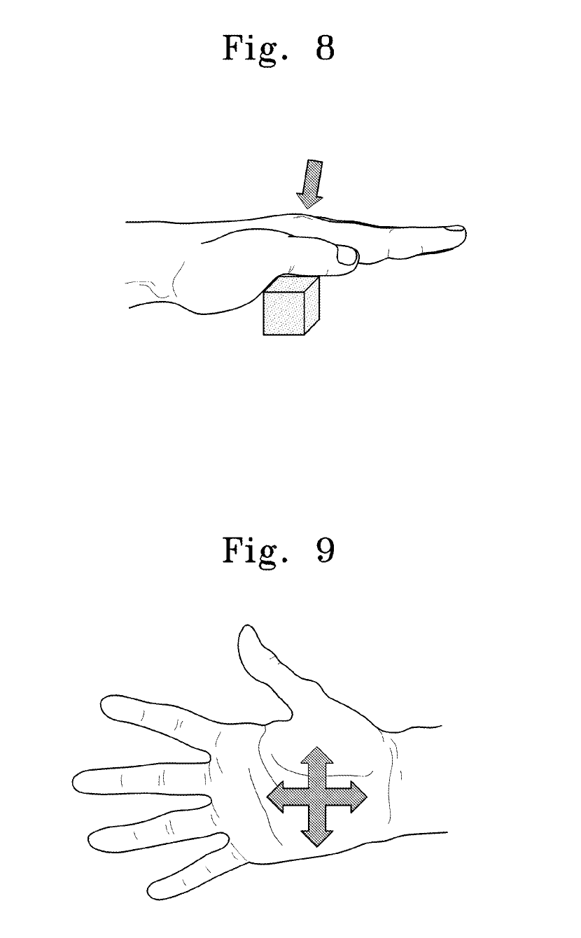

As illustrated in FIG. 8, objects may be moved up or down by cupping the hand or moving a palm down horizontally.

As illustrated in FIG. 9, objects may be panned in all three dimensions by spreading the palm, moving it as if moving the scene and rotating it at will around all three axes.

Alternatively, panning may be achieved by “grabbing” the scene by closing the fist, moving it to pan and rotating it to change scene rotation at will, as if rotating a real object, including pitch and yaw. Selection may be optional if the number of objects is small. In such cases, the objects may be “pushed around” as if they were floating in a physical volume

Note that for additional user convenience, instead of holding the mobile device continuously with one hand, the device may be placed on the user's lap. In particular, holding the device oriented vertically may make it easier for the user to reach behind the device.

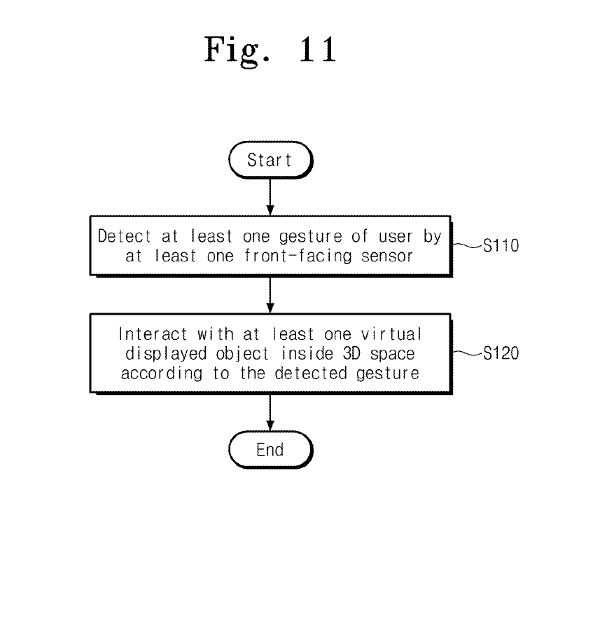

FIG. 11 is a flow chart illustrating a gesture control method of a mobile device according to some example embodiments of inventive concepts.

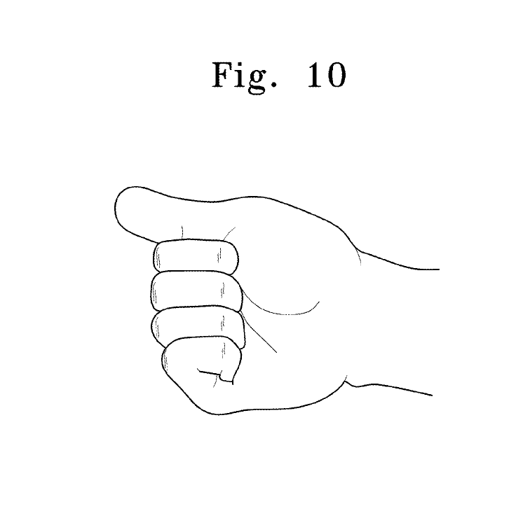

Referring to FIGS. 1 to 11, in operation S110, a front-facing sensor 122 may detect at least one gesture of a user. In operation S120, at least one object may be interacted within a virtual three-dimensional space according to the detected gesture. This may be made the same or substantially the same as that described with reference to FIGS. 4 to 10. With the gesture control method of a mobile device 100 of some example embodiments of inventive concepts, a virtual three-dimensional space placed in front of the mobile device 100 may interact with a gesture of a user.

A mobile device according to some example embodiments of inventive concepts may enable a user to interact with a three-dimensional interface driven by the mobile device without visual obstruction, to reach a virtual three-dimensional space, and to operate virtual objects.

The mobile device according to some example embodiments of inventive concepts may perform interacting applications having three-dimensional visualization.

While example embodiments of inventive concepts have been described with reference to some example embodiments, it will be apparent to those skilled in the art that various changes and modifications may be made without departing from the spirit and scope of the present invention. Therefore, it should be understood that the above example embodiments are not limiting, but illustrative.

What is claimed is:

1. A gesture control method for a mobile device that provides a three-dimensional interface, comprising:
displaying a virtual three-dimensional space using the three-dimensional interface;
detecting at least one gesture of at least one user using at least one front-facing sensor; and
moving an object existing in the virtual three-dimensional space according to the detected gesture such that the at least one user interacts with the virtual three-dimensional space.

2. The gesture control method of claim 1, further comprising:
generating an avatar corresponding to a hand of the at least one user based on location information of the at least one user.

3. The gesture control method of claim 1, further comprising:
displaying a three-dimensional scene corresponding to a still space in the virtual three-dimensional space, such that the at least one user is immersed in the three-dimensional space, the still space associated with a peripheral circumstance of the at least one user;
displaying the three-dimensional scene as if a cube is floated in the still space; and
changing an appearance of the cube displayed according to a motion of the mobile device or the at least one user when the mobile device or the at least one user moves, such that a location of the cube is not moved within the three-dimensional space.

4. The gesture control method of claim 3, wherein the changing an appearance of the cube comprises:
displaying a left side of the cube more compared with the appearance of the cube before the at least one user moves if a head of the at least one user moves leftward.

5. The gesture control method of claim 1, further comprising:
acquiring and tracing coordinates of eyes of the at least one user within a physical three-dimensional space using the at least one front-facing sensor.

6. The gesture control method of claim 5, further comprising:
varying the virtual three-dimensional space according to the coordinates of the eyes such that the at least one user is immersed in the virtual three-dimensional space.

7. The gesture control method of claim 1, further comprising:
displaying the virtual three-dimensional space to superimpose the virtual three-dimensional space on a physical scene that the at least one users watches.

8. The gesture control method of claim 1, further comprising:
generating an avatar of the at least one user in the virtual three-dimensional space; and
communicating with another user other than the at least one user using the generated avatar.

9. The gesture control method of claim 1, further comprising:
selecting an object of the virtual three-dimensional space based on pinching by the at least one user.

10. The gesture control method of claim 9, further comprising:
entering a resizing mode for resizing the object selected based on squeezing by the at least one user.

11. The gesture control method of claim 10, further comprising:
terminating the resizing mode when the selected object is not resized during a desired time.

12. The gesture control method of claim 9, further comprising:
moving the object based on pushing the object with at least one of a hand of the at least one user and a hand of an avatar corresponding to the hand of the at least one user.

13. The gesture control method of claim 9, further comprising:
panning the object based on rotating the object with at least one of a hand of the at least one user and a hand of an avatar corresponding to the hand of the at least one user.

14. A mobile device that provides a three-dimensional interface, comprising:
a communication unit configured to perform wireless communication;
a memory unit configured to store user data and data;
a display unit configured to display a virtual three-dimensional space using the three-dimensional interface;
a sensing unit configured to sense a still picture and a moving picture of a physical space and including at least one front-facing sensor configured to sense at least one gesture of a user; and
at least one processor configured to control the communication unit, the memory unit, the display unit, and the sensing unit,
wherein the at least one processor moves an object existing in the virtual three-dimensional space according to the detected gesture, and
when the mobile device or the user moves, the at least one processor controls the three-dimensional interface such that a sight of the user toward the object is varied.

15. The mobile device of claim 14, wherein the front-facing sensor is a time-of-flight camera.

16. A gesture control method of a mobile device configured to provide a three-dimensional interface, the method comprising:
displaying a first portion of a virtual three-dimensional space so that the first portion is superimposed on a physical space, using the three dimensional interface;
displaying a second portion of the virtual three-dimensional space using the three-dimensional interface;
detecting at least one gesture of at least one user using at least one of one or more front-facing sensors and one or more back-facing sensors; and
moving an object existing in the virtual three-dimensional space according to the detected gesture such that the at least one user interacts with the virtual three-dimensional space.

17. The gesture control method of claim 16, wherein the second portion of the virtual three-dimensional space includes a floating cube.

18. The gesture control method of claim 17, further comprising:
changing an appearance of the cube according to a motion of the mobile device or the at least one user when the mobile device or the at least one user moves, such that a location of the cube is not moved within the three-dimensional space.

19. The gesture control method of claim 16, further comprising:
generating a hand of an avatar corresponding to a hand of the at least one user based on location information of the at least one user.

20. The gesture control method of claim 19, further comprising:
interacting with an object in the virtual three-dimensional space based on movement of the hand of the avatar.
